(19) United States
(12) Patent Application Publication
(10) Pub. No.: US 2008/0193239 A1
(43) Pub. Date: Aug. 14, 2008

(54) Portable Multi-Function Machine Tool

(76) Inventors: Edward R. Elliott, Gloucester, VA (US); Craig Messick, Yorktown, VA (US); Raymond Stallings, Yorktown, VA (US); George Santoni, Newport News, VA (US); Bill (William) J. Price, Newport News, VA (US); Lenvil Holland, Smithfield, VA (US); Danny Nelms, Fort Mills, SC (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 12/019,977

(22) Filed: Jan. 25, 2008

Related U.S. Application Data
(60) Provisional application No. 60/886,563, filed on Jan. 25, 2007.

(51) Int. Cl. B23C 1/20

(52) U.S. Cl. 409/131; 409/231

(57) ABSTRACT

A portable multifunction machine tool (PMMT) for performing operations upon a work structure. The PMMT has a movable frame attached to and structured to provide support for a tool carriage that is movably connected to the frame and that comprises at least one machine tool assembly adapted to receive a tool. The PMMT also has a processor communicatively connected to the tool carriage and machine tool assembly and programmed to control the movement of the tool carriage.

This application claims priority to U.S. Provisional Application No. 60/886,563, filed Jan. 25, 2007, which is incorporated herein by reference in its entirety.

### FIELD OF THE INVENTION

This invention relates generally to a portable multifunction machine tool.

### BACKGROUND OF THE INVENTION

Work structures may be taken to the location of machine tools for machining the work structures. However, work structures may be large or otherwise such that transportation of the work structure to the machine tool may not be practically possible or efficient. In many industries, large structures fabricated from precisely machined substructures cannot easily be dismantled or returned to a shop for refurbishment or modification. This is particularly true in the marine industry. Naval vessels and other ships often require overhauls in which such structures must be re-machined or modified to new specifications. This has generally required the use of labor intensive individual tools to perform operations such as drilling, reaming, tapping, etc. The result is a costly operation with potentially questionable accuracy.

A machine tool that is able to be transported to a work structure, positioned properly relative to the work structure, and perform multiple and repetitive machining functions upon a work structure is needed. The present invention is able to perform those tasks.

### SUMMARY OF THE INVENTION

The present invention is a portable multifunction machine tool for performing machining operations upon a work structure. An exemplary embodiment of the present invention comprises a frame attached to and structured to provide support for a movable tool carriage, a tool carriage that is movable within the frame and that comprises at least one machine tool assembly, and a processor to control the movement of the tool carriage to specific locations such that tools attached to the machine tool assembly may perform operations at specific areas upon the work structure. In that exemplary embodiment, the frame and tool carriage are adapted to allow the tool carriage to move so that the tool assembly can be positioned for machining the work structure.

### BRIEF DESCRIPTION OF THE DRAWINGS

FIG. 1 depicts a top view of a portable multifunction machine tool according to an embodiment of the invention.

FIG. 2 depicts a side view of a portable multifunction machine tool according to an embodiment of the invention.

FIG. 3 depicts a front view of a portable multifunction machine tool according to an embodiment of the invention.

FIG. 4 depicts a planar alignment clamp/pusher according to an embodiment of the invention.

FIG. 5 depicts a lower stabilizer on a section of a portable multifunction machine tool according to an embodiment of the invention.

FIG. 6 depicts a hold down clamp on a section of a portable multifunction machine tool according to an embodiment of the invention.

FIG. 7 depicts a planar alignment arm on a section of a portable multifunction machine tool according to an embodiment of the invention.

FIG. 8 depicts a vision system camera on a section of a portable multifunction machine tool used with a laser light to align a portable multifunction machine tool according to an embodiment of the invention.

FIG. 9 depicts a corner support screw on a section of a portable multifunction machine tool according to an embodiment of the invention.

FIG. 10 depicts a remaining hole drill fixture (RHDF) that can be used as a template according to an embodiment of the invention.

FIG. 11 depicts a portable multifunction machine tool processor according to an embodiment of the invention.

FIG. 12 depicts a method of using an embodiment of the portable multifunction machine to perform a machining operation on a fixed work surface having a known geometry and topography according to an embodiment of the invention.

### DETAILED DESCRIPTION OF EXEMPLARY EMBODIMENT(S)

A portable multifunction machine tool (PMMT) is disclosed. The PMMT is designed to perform a plurality of machining operations that would otherwise be highly labor intensive and would require multiple task-specific tools or machines. The PMMT can be transported to a particular work location for use in machining structures that would otherwise be difficult or impossible to dismantle and transport to a machine shop or other facility for refurbishment or modification. Once on-site, the PMMT can anchor itself relative to a fixed working structure, establish a location index (at times herein called a “reference point”) and perform a variety of machining operations at multiple locations on the fixed working surface, each location being precisely established relative to the location index. The PMMT may comprise an arrangement for identifying and establishing a reference point to which all machining operations are indexed.

The PMMT has a frame to which a tool carriage is attached. The PMMT is movable to a particular work location where a work structure or structures may be located. Upon the PMMT being placed at the work location and in close proximity to the work structure, the PMMT and/or work structure or structures may be positioned so that the PMMT is in a starting position relative to the work structure or structures such that the PMMT's pre-programmed operations and/or sequences of operations properly match the physical configuration of the work structure or work structures. Different geometries may be programmed into the PMMT's processor. As long as the geometry and desired operations are known, the processor may be programmed accordingly.

Once the initial proper relative position of the PMMT has been established, the PMMT frame may be anchored relative to the work structure. Depending upon the structure of the particular PMMT embodiment and the operation to be performed, the weight of the PMMT may be sufficient for the PMMT frame to maintain a set position such that operations may be performed without the PMMT frame being anchored down. The maintenance of the initial relative position, by anchoring and/or the weight of the PMMT, ensures that the movement of the tool carriage in relation to the frame (such as moving within and/or around the stationary frame) is in proper position in relation to the work structure or structures upon which machining operations are to be performed. The frame may be anchored to prevent movement of the frame in one, several, and/or all directions. The PMMT frame may be constructed of such materials that provide sufficient rigidity that the frame, once placed into a set position, maintains such relative position with the work structure or work structures. For instance, the frame may be constructed from metals and its members configured as beams, pipes, angle irons, or other configurations that would provide sufficient rigidity.

The PMMT has a tool carriage attached to and movable within and/or about the PMMT frame. The tool carriage may be located partially or completely within the frame, outside the frame, and/or surrounding, in whole or part, the frame. The tool carriage provides the structure to which the operating tools are attached while performing some or all of the PMMT operations. The tool carriage includes at least one machine tool assembly, which may comprise one or more spindles adapted to receive any of various tools. A spindle may be operatively mounted to a tool drive attached to the tool carriage. Alternatively, the machine tool assembly may comprise such other device that would effectuate an action upon a work structure; for instance, a reciprocating saw or a pneumatic nail gun. The frame and tool carriage are adapted to allow the tool carriage to move through a pre-defined space so that the tool assembly can be positioned for performing an operation upon a desired work structure area.

The PMMT has a processor that is programmed to control the movement of the tool carriage to specific locations such that tools attached to the machine tool assembly may perform operations at specific areas upon the work structure. The operations may be machining operations or other operation performable with a tool. Once the desired relative position between the PMMT and work structure has been established at the work area, the frame maintains its location and provides the structure within and/or around which the tool carriage may move pursuant to the control of the PMMT processor. Once desired operations have been performed on the work structure that are accessible with the frame located at its set position, the frame and PMMT may be moved to a subsequent starting position from which the tool carriage may move within and/or about the frame, pursuant to control of the processor, such that the machining operations may be performed at additional areas of the work structure and/or other work structures.

Certain embodiments of the PMMT may have rings, hooks, chains or other structures attached to and a part of the frame and/or tool carriage upon which a force may be applied to move the PMMT to a work location to perform operations on a work structure or structures. The PMMT embodiments may have structures known for facilitating movement of the frame, such as wheels, rollers, rails, or slides, upon which the PMMT frame may be moved to a work location. Certain embodiments may have a self-contained power system for moving the PMMT, such as a self-contained hydraulic, electric, or pneumatic system; i.e., the PMMT may be self-propelled. The PMMT may be connectable to sources of power not contained within the PMMT.

The PMMT tool carriage is movable within and/or about the PMMT frame. The tool carriage provides the structure to which the operating tools are attached while performing some or all of the PMMT operations. The tool carriage may be movably connected to the frame by a carriage transport assembly configured to support the tool carriage and to allow controlled movement of the tool carriage within the frame interior space. The tool carriage may move upon structures known for facilitating movement, such as wheels, rollers, rails, racks and pinions, or slides. For instance, the tool carriage may move horizontally along horizontal rails and vertically upon vertical rails. The tool carriage may include articulating extensions that permit extended movement. The tool carriage may also rotate upon axes, which may be desired when operations are being performed upon a concave, convex, or flat surface or when the operation is otherwise being performed in a concave or convex manner (the operation need not be limited to the geometry of a surface). The PMMT includes a carriage drive arrangement configured to move the tool carriage according to received movement commands. Certain embodiments may have a self-contained power system for moving the tool carriage within the frame, such as a self-contained hydraulic, electric, or pneumatic system. Certain embodiments may be connectable to sources of power not contained within the PMMT. The tool carriage may have multiple degrees of freedom. The tool carriage may be movable along any line of direction and rotational upon any axis. Thus, the tool carriage may permit tool operation upon, above, and/or below a flat, convex, concave, or other configured work structure surface. The movement of the tool carriage is not limited to uniform geometries but rather may include non-uniform geometries. As long as the geometry and desired operations are known, the tool carriage may be moved accordingly.

Upon the PMMT being placed at the work location and in close proximity to the work structure, the PMMT frame may be positioned so that the PMMT is in a starting position such that the PMMT's pre-programmed operations and/or sequences of operations properly match the physical configuration of the work structure or work structures. The PMMT may be positioned by known methods of positioning. For instance, the PMMT may be positioned by visual alignment to a reference location or locations, by placement of a portion or portions of the PMMT against, on, in, or otherwise in relative position to portions of the work structure and/or work area (or against, on, in, or otherwise in relative position to temporary structures, such as spacers, that themselves are in relative position to structures of the work structure and/or work area) such that the PMMT is in a proper starting position relative to the work structure, by placement of the PMMT in relation to laser lights, chalk lines, or other markers that would identify the proper placement of the PMMT in relation to the work structure. Alternatively, after the PMMT has been transported to the work area, the work structure itself may be repositioned relative to the PMMT in order to place the PMMT in proper position relative to the work structure. Alternatively, both the work structure and the PMMT may be moved in order to establish the proper relative position.

Once the initial proper relative position of the PMMT has been established, the PMMT frame may be anchored relative to the work structure. The PMMT frame may be anchored by clamps (operated hydraulically, manually, or otherwise), screws, bolts, electromagnets, or by any other known manner that would anchor the PMMT frame relative to the work structure. Depending upon the structure of the particular PMMT embodiment and the operation to be performed, the weight of the PMMT may be sufficient for the PMMT frame to maintain a set position such that operations may be performed without the PMMT frame being anchored down.

The PMMT has a processor that is programmed to control the movement of the tool carriage to specific locations such that tools attached to the machine tool assembly may perform operations at specific areas of the work structure. Once the desired relative position between the PMMT and work structure has been established at the work area, the frame maintains its location and provides the structure within and/or around which the tool carriage may move pursuant to the control of the PMMT processor.

Different geometries may be programmed into the processor as a “map” of the work structure. For example, in addition to planar surfaces, cylindrical surfaces may be programmed such that the tool carriage rotates on an axis while tool operations are being performed. The geometries that may be programmed are not limited to surfaces, and tool operations performed may involve a depth component such that instead of or addition to performing tool operations upon a surface, the tool carriage is movable such that tool operations may be performed above and/or below a surface, including into a work structure. The physical geometries that may be programmed into the processor are not limited to uniform geometries but rather may include irregular or otherwise non-uniform geometries, including non-uniform surfaces. As long as the geometry and desired operations are known, the processor may be programmed accordingly.

In addition to programming the processor with the geometry of the work structure, the processor is also programmed with the desired tool carriage and tool assembly movements and/or points of engagement for the desired tool operations. For instance, the processor may be programmed that a work structure is a rectangular structure with dimensions of fifteen meters length, three meters height, and sixteen centimeters thickness, that the tool carriage and tool assembly are to begin operations at a specified position relative to a reference point on the structure, and that from that initial position the tool carriage (more specifically, a specific point on the tool carriage) is to move to a height of one foot, then move laterally in a specified direction two meters, and the tool assembly is to then activate (for instance, if the tool assembly is a spindle, the spindle would begin rotating at a rotational speed programmed into the processor) and then move toward and normal the work structure surface until the tool assembly had so moved six centimeters in distance, at which point the tool assembly could reverse its direction of movement for six centimeters (i.e., retract to its initial position), the tool carriage then move two meters further laterally in the same lateral direction previously moved, the spindle repeat its movements previously described, and such sequences of movements repeat as often as specified by the programming of the processor. The work structures upon which the PMMT may perform operations are not limited to any particular dimension and the dimensions provided in the preceding sentence are simply exemplary dimensions of a work structure. In a different embodiment, simply the locations and types of operation, rather than the movements, could be programmed into the processor and the processor could determine the movements necessary to effectuate such operations at such locations.

For further example, the operation to be performed may be to drill fifteen holes at a height of one meter above the floor with the initial hole to be drilled at an initial point on the wall and each hole thereafter to be drilled, in a particular direction along the wall, ten centimeters from the preceding drilled hole. In such instance, the PMMT would be placed in proximity of the wall, the PMMT would be positioned, in relation to a reference point/location index, such that while the frame maintained its set position the tool carriage could move along the length of the wall and drill a plurality of the holes, under direction of the processor, which would be programmed with the spatial information pertinent to the drilling operation such as the location, relative to the frame, of the initial hole to be drilled, the depth to be drilled, and the distance and direction the tool carriage would need to move to drill at the hole locations accessible to the tool carriage from the initial set position of the PMMT frame. If further work structure areas at which holes were to be drilled were not accessible to the tool carriage from the initial set position of the PMMT frame; once the holes at the then accessible locations were drilled, the PMMT could be moved further along the wall, the frame positioned into another initial starting position with regards to a new reference point, the frame position be set by its weight or by anchoring, and the tool carriage moved, pursuant to control by the processor, in relative position to the frame while drilling such hole locations then accessible.

The processor may include a memory module for storing information pertaining to the operations of the PMMT; for example, the geometry of the work structure or structures, the geometry of the PMMT components, the location and positions of one or more PMMT components in relation to another and/or other PMMT components, the location and positions of one or more PMMT components in relation to one or more work structures once the PMMT or a component thereof has been placed into a specified reference location in relation to the work structure(s) and thereafter (i.e., as the PMMT and/or its components are moved as directed by the processor), and the programmed movements of the tool carriage and tool assembly. Alternatively or in addition thereto, the processor may be configured to permit the attachment to it of temporary memory containing such information.

The processor comprises several modules, besides memory. One module (initial position module) may calculate the initial locations of one or more components of the PMMT (particularly the tool carriage, tool assembly, and/or tool attachment point, i.e., the point that the tool attaches to the tool assembly), the tool, and/or point(s) at which the tool engages the work structure (e.g., the tip of a drill bit [in such instance, the processor could be programmed with the spatial information as to the distance from the drill bit tip to the tool attachment point or to another reference point of the PMMT]). “Initial location” refers to location once the PMMT frame has placed into a position (and anchored, if anchoring is used) that will be maintained while tool operations are performed without the frame moving. For example, as more fully described in the specific embodiment described further below, the processor determines initial location information based, in part, from information communicated to the processor from a sensor that is in registration with and senses a light source projected through a hole that serves as a reference point and, in part, from preprogrammed information regarding the dimensions of a catapult trough and the PMMT. Initial location may be precisely predetermined and thus not calculated, for instance if use of the PMMT is based upon the PMMT being placed into a precise position relative to the work structure(s) such that, upon such placement, initial location is known without need for calculation by the processor.

The PMMT processor is programmed to command a sequence of movements of the tool carriage and tool assembly, prior to any precise holemaking operation. Once programmed, it is a very accurate indication of how far the machine is from any pre-set programmed position once the machine has been properly placed into that position. The processor may include a memory module for storing information pertaining to the operations of the PMMT; a carriage controller for providing movement commands to the tool carriage and a tool controller for providing tool operation commands thereto. The controllers may be CNC (computer numerical control) controllers. The carriage controller may comprise an indexing module configured to orient carriage locations to positions on the work surface map based on establishing at least one initial position of the carriage relative to the work surface.

The processor may also be communicatively connected to sensors that provide locational information and/or to a user interface. In some embodiments, some or all of the processor modules may be integrated into a single module.

The PMMT of the present invention provides a single machine that can be used for multiple machining operations on large structures “in-the-field.” A particular embodiment of the PMMT was developed for use in machining trough sections of a catapult system used to launch aircraft from the decks of aircraft carriers. A typical catapult trough is a long trough and may require many holes to be drilled and tapped. Individual trough sections must have all holes precisely located relative to one another. Large areas of the catapult trough may also require face milling.

The various machining operations must be conducted with the catapult troughs in-place on the carrier deck. This embodiment of the PMMT can be used to perform various machine operations on the catapult trough, such as drilling, tapping, grinding, milling, chamfering, countersinking, and spot facing.

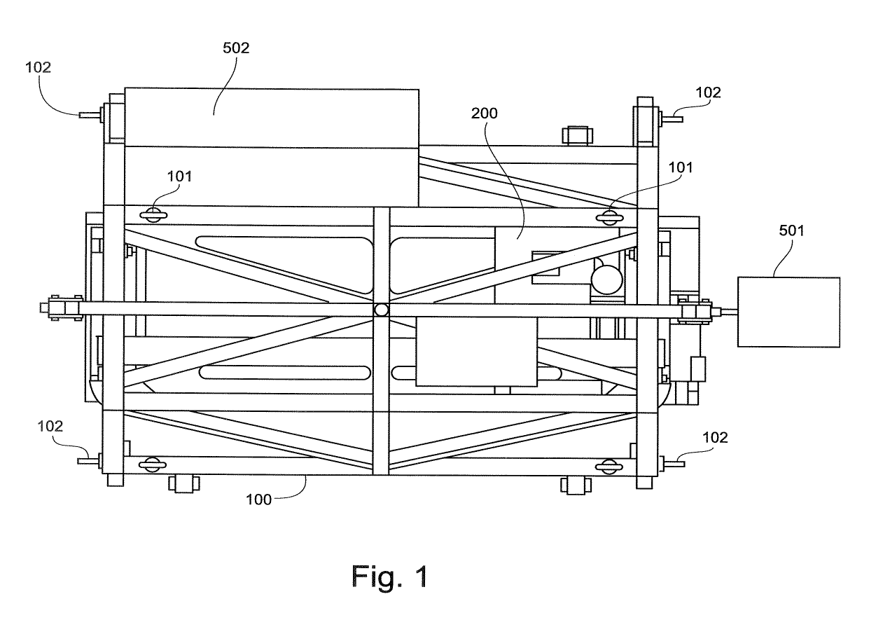

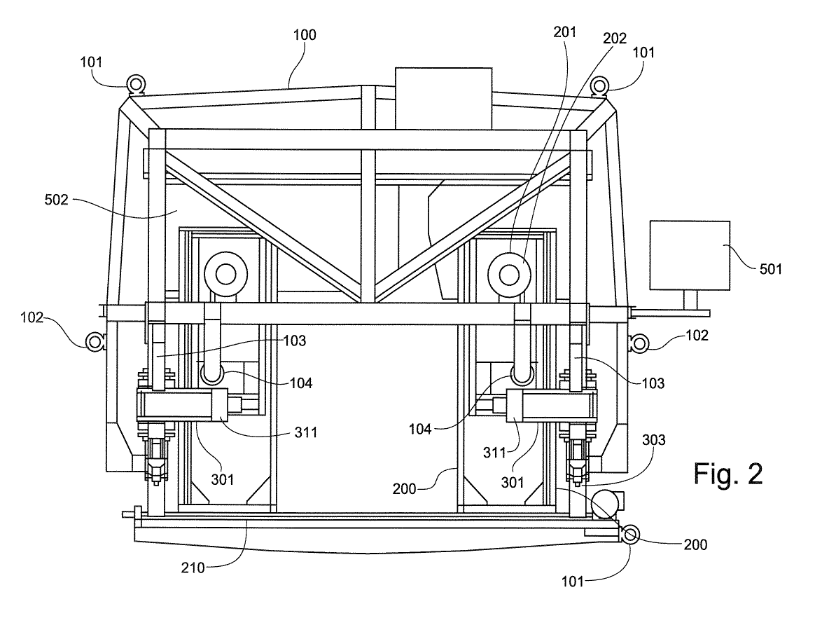

FIGS. 1-9 illustrate an embodiment of the PMMT configured for use in conducting machining operations on the above-described catapult trough. The PMMT comprises a frame structure (100) structured to provide support for a movable tool carriage (200). The frame structure (100) defines a frame interior space and is orientable to a desired position relative to a fixed work surface. The PMMT is equipped with vertical hoist rings (101) and horizontal hoist rings (102) mounted to the frame structure(100) of the machine. Vertical hoist rings (101) are located at the top of the PMMT and are suited for lifting the machine by crane or other means. Upon being lifted to the catapult trough, the weight of the PMMT is supported by the alignment wheels (103) which rest upon the deck of the carrier with two alignment wheels (103) positioned on one side of the trough and two alignment wheels (103) positioned on the other side of the trough (i.e., the four wheels straddle the trough) such that the portion of the PMMT that is lower than the alignment wheels (103) is within the trough, the trough being lower than the top of the aircraft carrier deck. The alignment wheels (103), in addition to providing support for the frame, can facilitate aligning, lifting and moving the PMMT.

The alignment wheels (103) are not to be confused with the lateral motion wheels (104), which, as described later below, aid in moving the PMMT frame structure (100) in the direction of the length of the trough while the frame structure is supported by the lateral motion wheels (104). Except for when the PMMT frame structure (100) is being moved along the direction of the trough length, the bottoms of the lateral motion wheels (104) are higher than the bottoms of the alignment wheels (103); i.e., the lateral motion wheels (104) are suspended without providing support to the PMMT frame structure (100). However, when the frame structure (100) is to be moved along the direction of the trough length, the lateral motion wheels (104) are lowered, hydraulically or otherwise, so that the PMMT weight is then transferred to and supported by the lateral motion wheels (104) rather than the alignment wheels (103) and, thus, the frame structure (100) may roll laterally.

In a different embodiment, the bottom portion of the frame structure (100) can rest upon the floor of the trough such to also provide support for the frame, however in the particular embodiment depicted and described, except as described above, only the alignment wheels (103) provide support for the frame structure and the bottom portion of the frame structure does not contact the floor of the trough, though the bottom portion of the frame structure is placed in close proximity to the trough floor. The frame structure (100) and tool carriage (200) are structured so that the spindle (202) may be positioned anywhere along a trough wall. The tool carriage (200) and tool assembly (201) may be configured for use on one side or both sides of the trough.

Additional horizontal hoist rings (102) are located on the ends of the machine and are available to aid in moving the machine laterally while the machine weight is being carried by lateral motion wheels (104). These horizontal hoist rings (102) can also be used to help move the machine down the length of the trough. The PMMT is placed into the trough with a minimal amount of clearance around the frame structure (100), the planar alignment arms (301), the planar alignment pushers/clamps (302), and the hydraulic lower hold-down clamps (303). The PMMT is connected to available sources of power, such as electrical and air services. Hydraulics may be used to facilitate alignment and clamping.

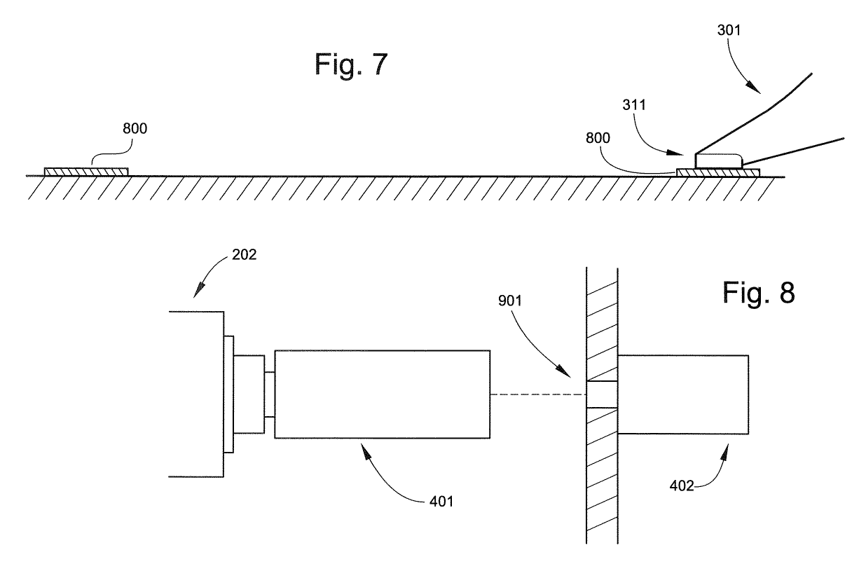

In this embodiment, after placement of the PMMT at the work area as described above, the PMMT may be aligned with a straight line that runs the length of the catapult trough. Periodically affixed along each side of the catapult trough down the length of the trough are rectangular pieces of metal called keyliners (800), as depicted in FIG. 7. The keyliners (800) are individually cut such to represent a true straight line down the length of the trough.

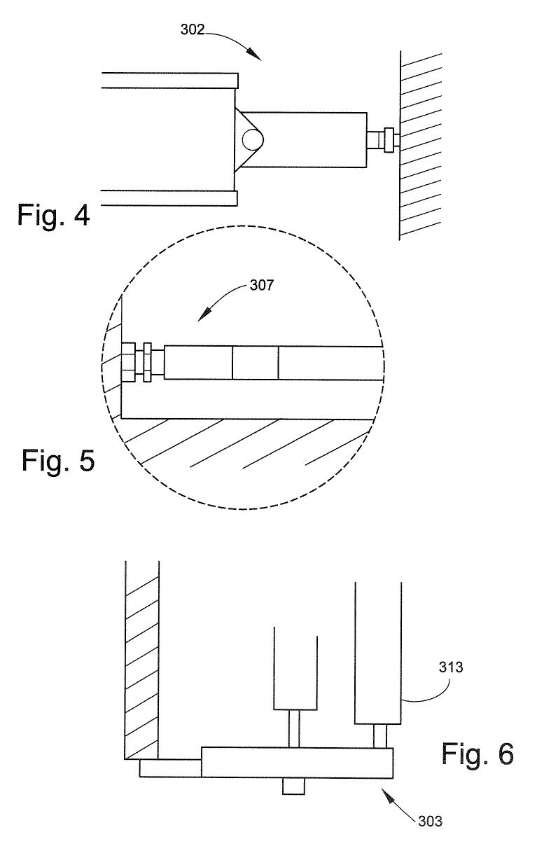

The planar alignment pushers/clamps (302) are located on one side of the PMMT, while the planar alignment arms (301) are located on the other side of the PMMT. As shown in FIG. 4, the planar alignment pushers/clamps (302) are hydraulically actuated to exert high forces against a catapult trough side wall. The force pushes the PMMT, which is resting on alignment wheels (103) toward the other trough wall on the other side of the PMMT such that planar alignment arm pads (311) located on the planar alignment arms (301) are pushed against the keyliners (800) located on that trough wall. In the depicted and described embodiment, the planar alignment arms (301) are rigidly and non-selectively attached to the PMMT frame structure (100). However, in other embodiments, the planar alignment arms (301) may be selectively positioned on the frame structure in such position as to effectuate the desired position and distance between the PMMT frame structure (100) and the planar alignment arm pads (311) as may be desired. The position and distance desired may be influenced by factors based upon the configurations of the PMMT frame structure (100) and the work structure and the particular operation to be performed upon the work structure.

The keyliners (800) are located a specific distance along the length of the trough. The planar alignment arms (301) are also located the same distance apart from each other such that the two planar alignment arms (301) can be positioned onto two keyliners (800). The forced movement of the surface of the planar alignment arm pads (311) onto the surface of the keyliners (800) causes the PMMT to shift and align with the plane established by the surfaces of the two keyliners (800). If, upon actuation of the planar alignment pushers/clamps (302), the complete surface of the planar alignment arm pads (311) do not come into contact with the surface of the keyliners (800), i.e., the pads (311) and keyliners (800) are not aligned, then the hydraulic force exerted by the planar alignment pushers/clamps (302) can be terminated and the PMMT can be moved, such as by exerting a force on the horizontal hoist rings (102), in the desired direction, such that upon reactivation of the planar alignment pushers/clamps (302), the entire surface of the planar alignment arm pads (311) will come into contact with the surface of the keyliners (800) such to effectuate alignment with the keyliners (800).

Depending upon the operation to be performed, the above alignment process may not be necessary and the operator of the PMMT may instead align the PMMT frame structure (100), in relation to the work structure, manually by sight.

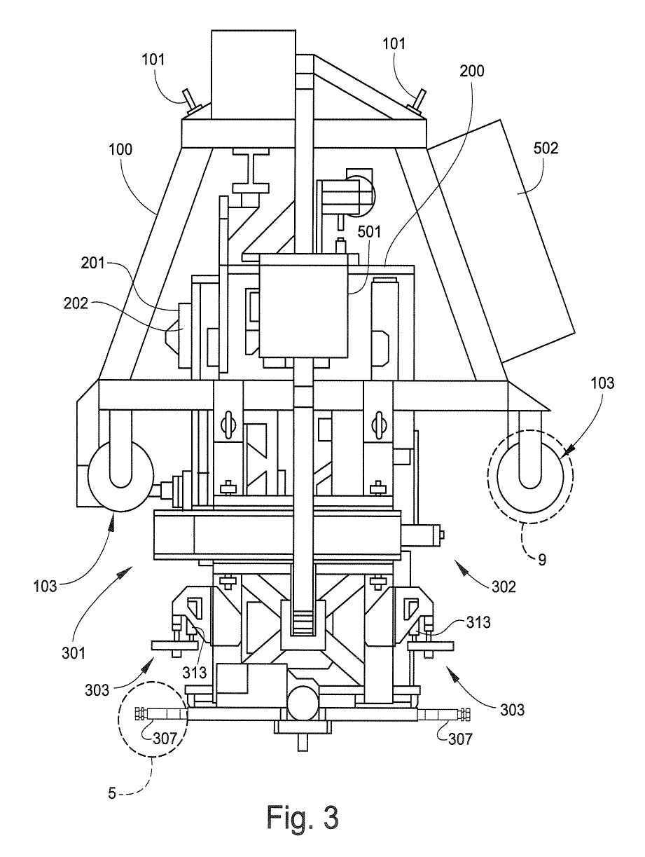

Once the PMMT is so aligned, the PMMT frame structure (100) is then anchored to prevent the movement of the frame structure during the operations of the tools upon the trough walls. The force exerted by the planar alignment pushers/clamps (302) against a trough wall is maintained such to help anchor the PMMT frame structure at its position. Additionally, as shown in FIG. 9 (which depicts the other side of the indicated cutout area in FIG. 3), corner support screws (306) may be located at each corner of the PMMT with the axis of each screw positioned normal to the surface upon which the PMMT rests. The screws may be lowered until they contact the surface upon which the PMMT rests. As shown in FIG. 5, lower screw stabilizers (307) may be inserted (i.e., the lower screw stabilizers (307) are insertable and removable) at the four corners of the PMMT base and adjusted to engage and exert a force against the trough sides.

As shown in FIG. 6, lower hold-down clamps (303) may be slid into position under the trough's lower backing bar (a rectangular bar that protrudes from the surface of each trough wall and extends along the length of the trough wall) at all four corners. A hydraulic actuator (313) can be activated to cause the lower hold-down clamps (303) to exert force under the lower backing bar. Thus so engaged, the planar alignment pushers/clamps (302), corner support screws (306), lower screw stabilizers (307), and lower hold-down clamps (303), along with the weight of the PMMT, anchor the PMMT frame structure (100) into its position and, thus, together form a frame structure anchoring arrangement.

The tool carriage (200) includes at least one machine tool assembly (201), which typically comprises one or more spindles (202) adapted to receive any of various tools. The frame structure (100) and tool carriage (200) may be adapted to allow the tool carriage (200) to move through a pre-defined volume so that the tool assembly (201) can be positioned for machining a desired surface. The tool carriage (200) may travel over guide rails (210).

Once the position of the PMMT has been aligned as described above and the PMMT frame structure anchored, the tool carriage (200), which is movable in relation to the PMMT frame structure (100) may be aligned such that the machine tool assembly (201) is initially positioned to permit an attached tool to operate upon an initial (for that set position of the PMMT frame structure (100)) location of the work structure. In this particular embodiment, the tool carriage (200) is movable horizontally (i.e., along the length of the PMMT frame structure (100)) and vertically (i.e., the tool carriage may raise or lower in order to be positioned at the correct height). However, in other embodiments the tool carriage may be movable in any direction.

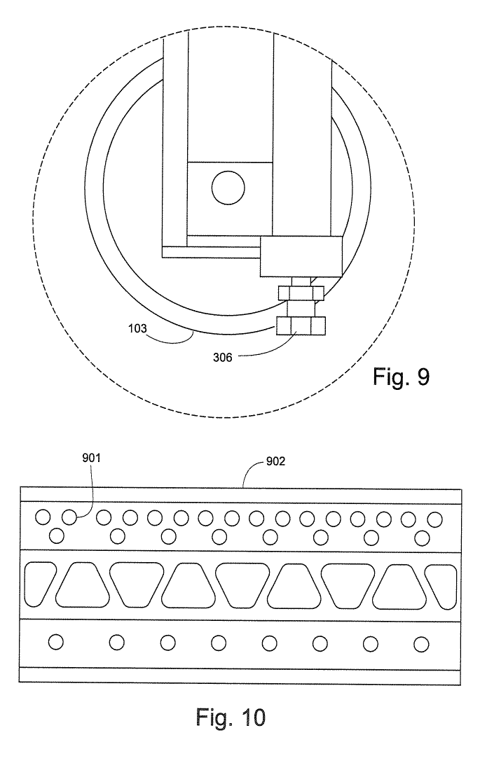

In this above described embodiment, tool carriage (200) alignment may be accomplished using a vision system camera (401) (shown in FIG. 9), a laser (402) (also shown in FIG. 8), and one or more reference holes in the keyliners, trough walls, or a template positioned against a trough wall. FIG. 10 depicts a remaining hole drill fixture (RHDF) (902) that serves as a template and that may be placed against the trough wall and indicate areas on the wall were tool operations may be performed. The laser (402) may be directed through a reference hole such that the emitted laser light shines toward and is approximately normal to the side of the PMMT, and, more specifically, such that the emitted laser light shines onto a sensor contained, temporarily or permanently, on or in the PMMT, that is able to detect the laser light. For instance, the laser (402) may be directed such that the laser light emits through reference hole (901) in FIG. 10. The laser (402) may be mounted at a known position on a work structure.

In this particular embodiment, the sensor is a vision system camera (401) that is temporarily (i.e., removably) attached to the block spindle. In this embodiment, the relation of the reference hole and the spindle has been predetermined and the spindle has been set into position such that, upon activation of the laser, the laser light will shine upon the vision system camera (401) such that the vision system camera (401) is able to detect the laser light. The vision system camera (401) is in communication with the processor (502). In response to the laser light information communicated from the vision system camera (401), the processor (502) controls the movement of the tool carriage (200) such that the spindle (202) is positioned so that the tool to be attached to the spindle (202) is properly aligned in relation to the work structure to begin performing operations upon the work structure when the spindle is thereafter activated with the tool attached. In the presently described embodiment, the processor (502) would move the tool carriage (200) vertically and/or horizontally within the anchored PMMT frame structure (100) in order to, in response to the information from the vision system camera, so position the spindle (202).

When aligned, the PMMT performs precise movement relative to an initial position set through the alignment process, that is, the location index. The PMMT is thus able to locate and move to positions relative to an index, and thereby perform machine operations in accordance with a pattern that is repeatable with precision. For example, applications requiring installation, repair and maintenance of structures having length or distance, such as pipes, catapult troughs, walls, columns, etc., are ideally suited for the PMMT. Indeed, the PMMT can benefit any field application requiring precise and repeatable machine movement.

Additionally, data entry and parameter selection and modification can be performed via a user interface station (501) (shown in FIGS. 1-3), which may also include controls for positioning the frame structure (100) and/or tool carriage (200) and may be in communication with the processor (502). The user interface station (501) may also include controls for initiating, maintaining, and/or terminating the operation of the spindle (202). In some embodiments, the user interface station (501) and the processor (502) may be integrated into a single station attached to the frame structure (100). One or both stations may also be remote from the PMMT.

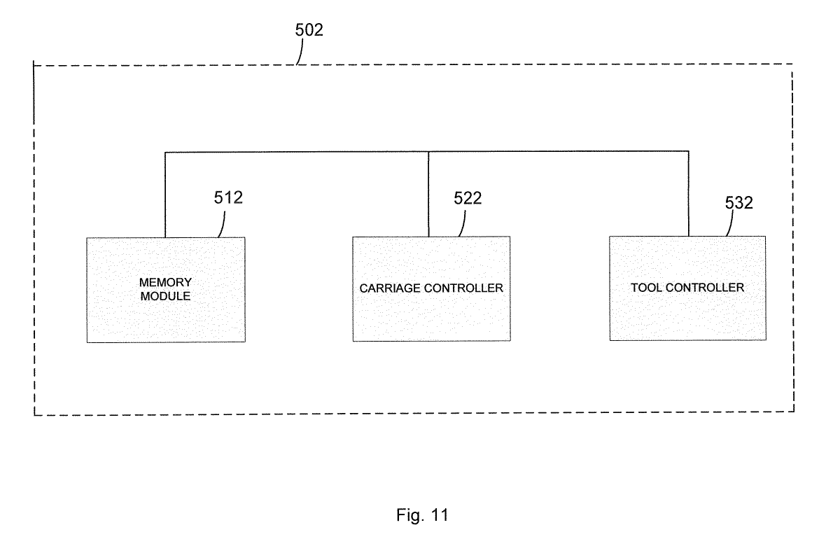

The PMMT processor (502) is programmed to command a sequence of movements of the tool carriage and tool assembly, prior to any precise holemaking operation. Once programmed, it is a very accurate indication of how far the machine is from any pre-set programmed position once the machine has been properly placed into that position. As depicted in FIG. 11, the processor (502) may include a memory module (512) for storing information pertaining to the operations of the PMMT; a carriage controller (522) in communication with the carriage drive for providing movement commands thereto, the carriage controller being configured to receive a map of the work surface and to command the carriage drive to position the tool carriage at a desired location relative to the work surface; and a tool controller (532) in communication with the tool drive for providing tool operation commands thereto.

This embodiment is designed to perform operations in the catapult trough, including: hole drilling, hole reaming, hole tapping, countersinking existing damaged holes to prepare for welding, and face milling of excess weld, key liners, and backing bars.

Some operations of the above described exemplary embodiment of the present invention will now be described.

Hole Drilling: The PMMT can be programmed to follow a variety of hole patterns for applications requiring hole drilling. Drilling parameters can be selected and modified to suit a variety of machining conditions. Such parameters include spindle speed, feed (i.e., movement of the spindle face toward and normal to a trough wall; for example, in a drilling operation the spindle would be feeding toward the trough wall) rate, feed depth, pecking (movement of the spindle toward a trough wall, followed by a slight movement away from the trough wall, which is repeated several times during drilling operations to break chips created during the drilling operation) distance, and pecking speed. Optimal feed and speed rates can be established and set for all machine operations. Parameters, once established, can be overridden to accommodate changes in material condition or to allow for decreased tool performance due to tool wear. The PMMT can be programmed to skip as many holes, work areas, or operations as desired.

Hole Reaming: The PMMT can operate in continuous and incremental feed modes. When in continuous mode, the PMMT will move at a set feed rate; when in incremental feed mode, the PMMT will move in discrete increments. The feed rate selection will affect the amount of incremental travel when the PMMT is in incremental mode. Drilling can be suspended or terminated at any time during the drilling cycle.

Hole Tapping: As with hole drilling, the PMMT can be programmed to follow a variety of hole patterns for applications requiring hole tapping. Tapping parameters can be selected and modified to suit a variety of machining conditions. Such parameters include spindle speed, feed rate, and feed depth. Optimal feed and speed rates can be established and set for various tapping operations. Parameters, once established, can be overridden to accommodate changes in material condition or to allow for decreased tool performance due to tool wear. The PMMT can be programmed to skip as many holes, work areas, or operations as desired.

The PMMT can operate in continuous and incremental feed modes. When in continuous mode, the PMMT will move at a set feed rate; when in incremental feed mode, the PMMT will move in discrete increments. The feed rate selection will affect the amount of incremental travel when the PMMT is in incremental mode. It may be preferable that the PMMT maintain constant feed and spindle rotation during the tapping cycle.

Hole Countersinking: As with hole drilling and tapping, the PMMT can be programmed to follow a variety of hole patterns for applications requiring hole countersinking. Countersinking can be used to, for example, prepare damaged holes for welding. Countersinking parameters can be selected and modified to suit a variety of machining conditions. Such parameters include spindle speed, feed rate, feed depth, pecking distance, and pecking speed. Optimal feed and speed rates can be established and set for various countersinking operations. Parameters, once established, can be overridden to accommodate changes in material condition or to allow for decreased tool performance due to tool wear. The PMMT can be programmed to skip as many holes, work areas, or operations as desired.

The PMMT can operate in continuous and incremental feed modes. When in continuous mode, the PMMT will move at a set feed rate; when in incremental feed mode, the PMMT will move in discrete increments. The feed rate selection will affect the amount of incremental travel when the PMMT is in incremental mode. Countersinking can be suspended or terminated at any time during the countersinking cycle.

Face Milling: The PMMT is capable of performing face milling using a face milling cutter. Face milling can be used, for example, to remove excess weld. Face Milling parameters can be selected and modified to suit a variety of machining conditions. Such parameters include spindle speed, feed depth, and feed rates along X, Y and Z axes. Optimal feed and speed rates can be established and set for various milling operations. Parameters, once established, can be overridden to accommodate changes in material condition or to allow for decreased tool performance due to tool wear. The PMMT can be programmed to mill on any axis.

Grinding: The PMMT is capable of performing grinding using a grinder. Grinding parameters can be selected and modified to suit a variety of machining conditions. Such parameters include spindle speed, feed depth, and feed rates along X, Y and Z axes. Optimal feed and speed rates can be established and set for various grinding operations. Parameters, once established, can be overridden to accommodate changes in material condition or to allow for decreased tool performance due to tool wear. The PMMT can be programmed to grind on any axis.

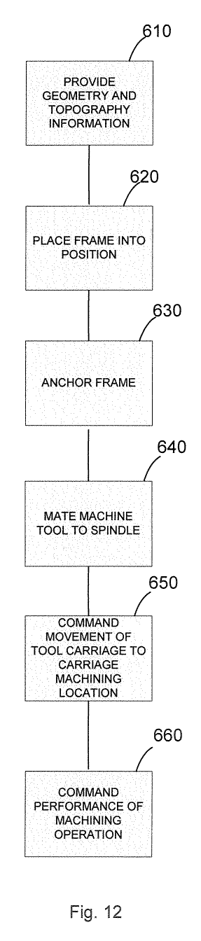

FIG. 12 depicts a method of using an embodiment of the PMMT to perform a machining operation on a fixed work surface having a known geometry and topography. In step (610), information on the work surface geometry and topography is provided to an automated control system of the PMMT. In step (620), the PMMT frame is placed adjacent to the fixed work surface in a predetermined machining position selected to allow machining operations in multiple locations on the fixed work surface. In step (630), the frame is anchored in the predetermined machining position. In step (640), a machine tool is mated to the spindle. In step (650), the tool carriage is commanded to move to a first carriage machining location adjacent a first work surface machining location. In step (660), the tool drive, spindle and first machine tool are commanded to perform a first machining operation on the work surface.

The embodiments of the present invention are not to be limited in scope by the specific embodiments described herein. Indeed, numerous variations, changes, substitutions and equivalents will be apparent to those skilled in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present invention can be beneficially implemented in any number of environments for any number of purposes. Accordingly, it is intended that all subject matter described herein and shown in the accompanying drawings be regarded as illustrative only and not in a limiting sense and that the scope of the invention be solely determined by the appended claims.

What is claimed is:

1. A portable multifunction machine tool for performing machining operations on a fixed work surface, the machining tool comprising:
a frame structure defining a frame interior space, the frame structure being orientable to a desired position relative to the fixed work surface;
a tool carriage movably connected to the frame by a carriage transport assembly configured to support the tool carriage and to allow controlled movement of the tool carriage within the frame interior space;
a carriage drive arrangement configured to move the tool carriage according to received movement commands;
a spindle operatively mounted to a tool drive attached to the tool carriage, the spindle being configured for receiving a machine tool and for selectively causing the machine tool to engage the fixed work surface to perform a machining operation; and
a carriage controller in communication with the carriage drive for providing movement commands thereto, the carriage controller being configured to receive a map of the work surface and to command the carriage drive to position the tool carriage at a desired location relative to the work surface.

2. The portable multifunction machine tool of claim 1, wherein the carriage controller comprises an indexing module configured to orient carriage locations to positions on the work surface map based on establishing at least one initial position of the carriage relative to the work surface.

3. The portable multifunction machine tool of claim 2, wherein the indexing module is configured to establish the initial position of the carriage relative to the works surface based at least in part on a signal from a sensor attached to the tool carriage.

4. The portable multifunction machine tool of claim 3, wherein the sensor is removably attachable to the spindle.

5. The portable multifunction machine tool of claim 3, wherein the sensor is a light sensor configured to provide a signal to the indexing module when the sensor is in registration with a light source mounted at a known position on the work surface.

6. The portable multifunction machine tool of claim 3, wherein the sensor is a light sensor configured to provide a signal to the indexing module when the sensor is in registration with a light source projecting through a hole in the work surface.

7. The portable multifunction machine tool of claim 1, further comprising:
a tool controller in communication with the tool drive for providing tool operation commands thereto.

8. The portable multifunction machine tool of claim 3, wherein the machining operation comprises at least one of the set consisting of drilling, grinding, milling, chamfering, countersinking, and spot facing.

9. The portable multifunction machine tool of claim 1 further comprising means for removably anchoring the frame structure in a desired position relative to the fixed work surface.

10. The portable multifunction machine tool of claim 1 further comprising at least one anchoring arrangement configured to prevent movement of the frame structure in at least one direction.

11. The portable multifunction machine tool of claim 10 wherein the anchoring arrangement includes at least one hydraulic actuator adapted for engaging the fixed work surface.

12. The portable multifunction machine tool of claim 10 wherein the anchoring arrangement comprises a clamp adapted for removable attachment to the work surface.

13. The portable multifunction machine tool of claim 1 further comprising a user interface station in communication with the carriage controller and the tool controller.

14. A method of performing a machining operation on a fixed work surface having a known geometry and topography, the method comprising:
providing a portable machine comprising a frame structure defining a frame interior space, a tool carriage movably connected to the frame and configured for controlled movement within the frame interior space, a spindle operatively mounted to a tool drive attached to the tool carriage, the spindle being configured for operatively receiving at least one machine tool for machining a surface, and an automated control system configured for control of carriage movement and operation of the tool drive, spindle and machine tool;
providing information on the work surface geometry and topography to the automated control system;
placing the frame structure adjacent the fixed work surface in a predetermined machining position selected to allow machining operations in multiple locations on the fixed work surface;
anchoring the frame structure in the predetermined machining position;
mating a first machine tool to the spindle;
commanding the tool carriage to move to a first carriage machining location adjacent a first work surface machining location; and
commanding the tool drive, spindle and first machine tool to perform a first machining operation on the work surface.

15. A method according to claim 14 further comprising:
commanding the tool carriage to move to a second carriage machining location adjacent a second work surface machining location.

16. A method according to claim 15 further comprising:
commanding the tool drive, spindle and first machine tool to perform a second machining operation on the work surface at the second work surface machining location.

17. A method according to claim 15 further comprising:
replacing the first machine tool with a second machine tool; and
commanding the tool drive, spindle and second machine tool to perform a second machining operation on the work surface at the second work surface machining location.

18. A method according to claim 14 further comprising:
replacing the first machine tool with a second machine tool; and
commanding the tool drive, spindle and second machine tool to perform a second machining operation on the work surface at the first machining location.

19. A method according to claim 14 wherein the machining operations comprise at least one of the set consisting of drilling, grinding, milling, chamfering, countersinking, and spot facing.

20. A method according to claim 14 further comprising:
locating an indexing location on the fixed work surface, the indexing location having a known position included in work surface geometry and topography information; and
positioning the tool carriage at a precise indexing position opposite the indexing location; and
correlating the tool carriage indexing position with the known position of the indexing location.

21. A method according to claim 20 wherein the action of positioning the tool carriage includes:
establishing the precise indexing position using a sensor system in communication with the automated control system, the sensor system comprising a sensor attached to the tool carriage and being capable of determining when the sensor is exactly opposite the indexing location.

22. A method according to claim 21 wherein the sensor is a light sensor that is removably attachable to the spindle and wherein the sensor system further includes a light source positionable at the indexing location of the fixed work surface.
